(19) United States
(12) Patent Application Publication
(10) Pub. No.: US 2023/0187847 A1
(43) Pub. Date: Jun. 15, 2023

(54) SWITCHED POLARIZATION FOR IMPROVED RELIABILITY OF CONNECTIVITY

(71) Applicant: NOKIA TECHNOLOGIES OY, Espoo (FI)

(72) Inventors: Benny VEJLGAARD, Gistrup (DK); Johannes HARREBEK, Aalborg (DK); Samantha CAPORAL DEL BARRIO, Aalborg (DK); Simon SVENDSEN, Aalborg (DK)

(73) Assignee: NOKIA TECHNOLOGIES OY, Espoo (FI)

(21) Appl. No.: 17/999,328

(22) PCT Filed: May 11, 2021
(86) PCT No.: PCT/FI2021/050350

§ 371 Date: Nov. 18, 2022

(30) Foreign Application Priority Data
May 20, 2020 (FI) 20205515

(51) Int. Cl. H01Q 21/24; H01Q 3/36; H04B 7/06

(52) U.S. Cl. CPC H01Q 21/245; H01Q 3/36; H04B 7/0695

(57) ABSTRACT

Disclosed is a method comprising transmitting or receiving, by a first terminal device (100), a first signal via a first antenna (1901), said first signal transmitted to or received from a second terminal device (102), and then switching, by the first terminal device, a polarization of the first antenna (1902), and then transmitting or receiving, by the first terminal device, a second signal via the first antenna (1903), said second signal transmitted to or received from the second terminal device.

### FIELD

The following exemplary embodiments relate to wireless communication.

### BACKGROUND

In device-to-device communication, for example sidelink communication, a terminal device may be utilized such that better service may be provided for directly communicating with another terminal device. This may enable better usage of resources and enhanced user experience to a user of a terminal device.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: transmit or receive a first signal via a first antenna, said first signal transmitted to or received from a second terminal device, switch a polarization of the first antenna, and transmit or receive a second signal via the first antenna, said second signal transmitted to or received from the second terminal device, wherein the apparatus is comprised in a first terminal device.

According to another aspect, there is provided an apparatus comprising means for transmitting or receiving a first signal via a first antenna, said first signal transmitted to or received from a second terminal device, switching a polarization of the first antenna, and transmitting or receiving a second signal via the first antenna, said second signal transmitted to or received from the second terminal device, wherein the apparatus is comprised in a first terminal device.

According to another aspect, there is provided a system comprising at least a first terminal device and a second terminal device, wherein the first terminal device is configured to transmit a first signal to the second terminal device via a first antenna, wherein the second terminal device is configured to receive the first signal via a second antenna, wherein the first terminal device is further configured to switch a polarization of the first antenna and transmit a second signal to the second terminal device via the first antenna, wherein the second terminal device is further configured to receive the second signal via the second antenna.

According to another aspect, there is provided a system comprising at least a first terminal device and a second terminal device, wherein the first terminal device comprises means for transmitting a first signal to the second terminal device via a first antenna, wherein the second terminal device comprises means for receiving the first signal via a second antenna, wherein the first terminal device further comprises means for switching a polarization of the first antenna and transmitting a second signal to the second terminal device via the first antenna, wherein the second terminal device further comprises means for receiving the second signal via the second antenna.

According to another aspect, there is provided a method comprising transmitting or receiving, by a first terminal device, a first signal via a first antenna, said first signal transmitted to or received from a second terminal device, switching, by the first terminal device, a polarization of the first antenna, and transmitting or receiving, by the first terminal device, a second signal via the first antenna, said second signal transmitted to or received from the second terminal device.

According to another aspect, there is provided a computer program comprising instructions for causing an apparatus to perform at least the following: transmit or receive a first signal via a first antenna, said first signal transmitted to or received from a second terminal device, switch a polarization of the first antenna, and transmit or receive a second signal via the first antenna, said second signal transmitted to or received from the second terminal device, wherein the apparatus is comprised in a first terminal device.

According to another aspect, there is provided a computer readable medium comprising program instructions for causing an apparatus to perform at least the following: transmit or receive a first signal via a first antenna, said first signal transmitted to or received from a second terminal device, switch a polarization of the first antenna, and transmit or receive a second signal via the first antenna, said second signal transmitted to or received from the second terminal device, wherein the apparatus is comprised in a first terminal device.

According to another aspect, there is provided a non-transitory computer readable medium comprising program instructions for causing an apparatus to perform at least the following: transmit or receive a first signal via a first antenna, said first signal transmitted to or received from a second terminal device, switch a polarization of the first antenna, and transmit or receive a second signal via the first antenna, said second signal transmitted to or received from the second terminal device, wherein the apparatus is comprised in a first terminal device.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates antenna polarization;

FIG. 3 illustrates a beam alignment procedure;

FIG. 4 illustrates an architecture for an apparatus;

FIG. 5 illustrates an architecture for an apparatus according to an exemplary embodiment;

FIG. 6 illustrates a switched polarization dual feed antenna array element according to an exemplary embodiment;

FIG. 7 illustrates some exemplary embodiments for device-to-device initial access for single polarization devices;

FIG. 8 illustrates some exemplary embodiments for 1:8 antenna array polarization split;

FIGS. 9-12 illustrate flow charts according to exemplary embodiments;

FIG. 13 illustrates some exemplary embodiments for radio resource control connected mode;

FIGS. 14-19 illustrate flow charts according to exemplary embodiments;

FIG. 20 illustrates an apparatus according to an exemplary embodiment.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

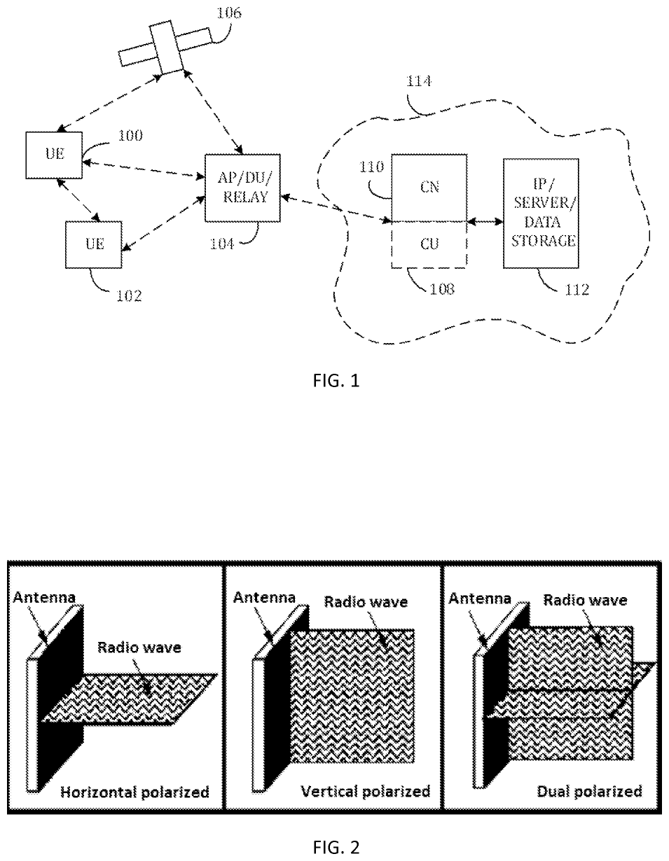

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB may be called uplink or reverse link and the physical link from the (e/g)NodeB to the user device may be called downlink or forward link. It should be appreciated that (e/g)NodeBs or their functionalities may be implemented by using any node, host, server or access point etc. entity suitable for such a usage.

A communication system may comprise more than one (e/g)NodeB, in which case the (e/g)NodeBs may also be configured to communicate with one another over links, wired or wireless, designed for the purpose. These links may be used for signaling purposes. The (e/g)NodeB may be a computing device configured to control the radio resources of communication system it is coupled to. The NodeB may also be referred to as a base station, an access point or any other type of interfacing device including a relay station capable of operating in a wireless environment. The (e/g)NodeB may include or be coupled to transceivers. From the transceivers of the (e/g)NodeB, a connection may be provided to an antenna unit that establishes bi-directional radio links to user devices. The antenna unit may comprise a plurality of antennas or antenna elements. The (e/g)NodeB may further be connected to core network 110 (CN or next generation core NGC). Depending on the system, the counterpart on the CN side may be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station.

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G may enable using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks may be network slicing in which multiple independent and dedicated virtual sub-networks (network instances) may be created within the same infrastructure to run services that have different requirements on latency, reliability, throughput and mobility.

The current architecture in LTE networks may be fully distributed in the radio and fully centralized in the core network. The low latency applications and services in 5G may require to bring the content close to the radio which leads to local break out and multi-access edge computing (MEC). 5G may enable analytics and knowledge generation to occur at the source of the data. This approach may require leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It may also be possible that node operations will be distributed among a plurality of servers, nodes or hosts. Application of cloudRAN architecture may enable RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may also comprise other apparatuses, such as physical layer relay nodes or other network elements, etc. At least one of the (e/g)NodeBs or may be a Home(e/g)nodeB. Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In multilayer networks, one access node may provide one kind of a cell or cells, and thus a plurality of (e/g)NodeBs may be required to provide such a network structure.

For fulfilling the need for improving the deployment and performance of communication systems, the concept of “plug-and-play” (e/g)NodeBs may be introduced. A network which may be able to use “plug-and-play” (e/g)Node Bs, may include, in addition to Home (e/g)NodeBs (H(e/g)nodeBs), a home node B gateway, or HNB-GW (not shown in FIG. 1). A HNB Gateway (HNB-GW), which may be installed within an operator's network, may aggregate traffic from a large number of HNBs back to a core network.

NR-Lite, which may also be referred to as NR-Light, may be used to address IoT-related requirements, which may not be fulfilled for example by enhanced machine type communication, eMTC, or narrowband Internet of Things, NB-IoT. Such requirements may be for example low complexity, enhanced coverage, long battery life, and/or support for a massive number of devices. A non-limiting list of examples of NR-Lite devices may comprise industrial sensors, relays, and/or integrated access and backhaul, IAB, nodes. Data rates of up to 10-100 Mbps may be required for example to support live video feed, visual production control, and/or process automation. Latency of approximately 10-30 ms may be required for example to support remote drone operation, cooperative farm machinery, time-critical sensing and feedback, and/or remote vehicle operation. Positioning accuracy of approximately 30 cm-1 m may be required for example to support indoor asset tracking, coordinated vehicle control, and/or remote monitoring. Some examples of features of NR-Lite may be reduced bandwidth operation, complexity reduction techniques, coverage and reliability enhancements, device-to-device communication, early data transmission, wake-up signal in idle mode, and/or grant-free transmission.

FIG. 2 illustrates antenna polarization. Polarization may be determined by the way an antenna is mounted, for example horizontally, denoted as H, or vertically, denoted as V. For optimal performance, like-polarized antennas may be used in line-of-sight wireless applications, for example in wireless communication between two devices with single-polarized antennas. Like-polarized means that both the transmit antenna and the receive antenna have the same polarization, for example that both are vertically polarized, thus forming a V-V channel, or that both are horizontally polarized, thus forming an H-H channel. Due to cross polar discrimination, XPD, properties, it may be possible to establish a wireless link using antennas with different polarities, but network performance and/or connectivity may be adversely affected as a result. XPD may be defined as the difference, for example in dB, between the peak of the co-polarized main beam, and the maximum cross-polarized signal over an angle twice the 3 dB beamwidth of the co-polarized main beam.

Dual-polarized antennas may feature a single antenna element, wherein two modes may be excited at the same time: one that is vertically polarized and one that is horizontally polarized. The vertical and horizontal elements may be formed by applying two different feeding points onto the same physical structure. When properly installed, dual-polarized antennas may communicate with both vertically and horizontally polarized antennas. An advantage of a dual-polarized antenna is that it may essentially provide two antennas in one package, which may save space and/or costs. Dual-polarized antennas may be used for example with MIMO wireless access points.

For NR terminal devices, the receiver, RX, may be required to support dual antenna MIMO, but this may not be required for the transmitter, TX. Since the gNB supports MIMO for both RX and TX, the polarization will line up when communicating between the gNB and such a terminal device.

On the other hand, a target for NR-Lite devices may be to support a single line up without MIMO. However, since the gNB is required to support MIMO for both RX and TX, it is sufficient for the NR-Lite device to support single polarization for polarization to line up between the gNB and the NR-Lite device.

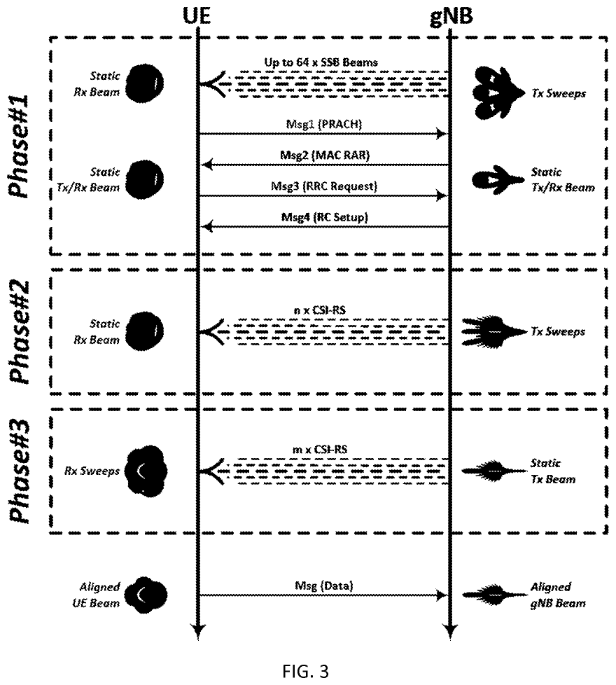

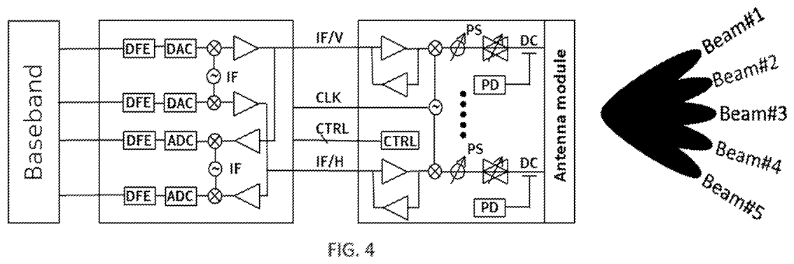

FIG. 3 illustrates a beam alignment procedure between a gNB and a terminal device, such as a beam alignment procedure according to 5G NR 3GPP release 15 described for example in 3GPP TR 38.802 section 6.1.6 and in TS 38.214 section 5.2. The beam alignment procedure comprises three main phases as illustrated in FIG. 3.

In phase 1, the terminal device, denoted as UE, is configured for broad beam RX, while the gNB performs downlink synchronization signal block, SSB, beam sweeping. The UE measures reference signal received power, RSRP, of the received SSB beams, and reports back to the gNB using the same beam configuration as in RX by selecting the random access resources, for example the random access channel, RACH, group, which correspond to the best SSB beam measured by the UE based on RSRP. The random access resources may be determined based on the information, for example master information block, MIB, system information block type 1, SIB1, and/or system information block type 2, SIB2, decoded by UE in correspondence with the best SSB beam.

In phase 2, the UE is configured for broad beam RX, while the gNB performs refined downlink channel state information reference signal, CSI-RS, beam sweeping. The UE measures RSRP, channel quality indicator, CQI, and/or rank indicator, RI, for the received CSI-RS and SSB beams, and reports the best beam ID based on the measurements back to the gNB using the same beam configuration as in RX.

In phase 3, the gNB transmits with the best beam determined in phase 2, and the UE sweeps refined RX beam settings for identification of the best narrow RX beam. At the end of phase 3, alignment between the gNB TX beam and the UE RX beam is obtained for maximized directional gain and minimum interference to other users in the serving and neighbor cells.

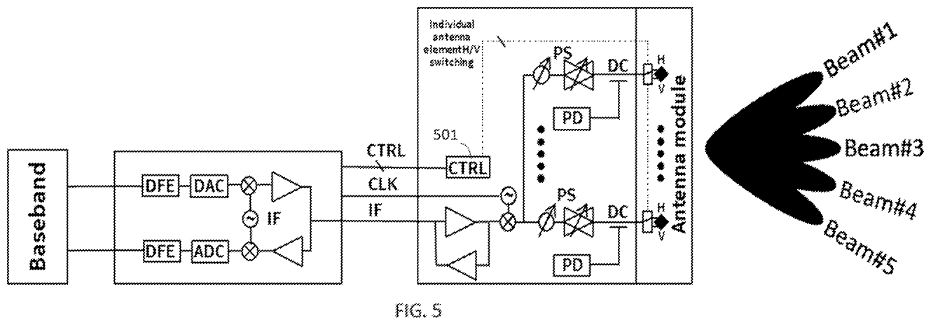

FIG. 4 illustrates an architecture for an apparatus with 2×2 MIMO. 2×2 MIMO refers to the apparatus comprising two transmit antennas and two receive antennas. The apparatus illustrated in FIG. 4 may be an apparatus such as, or comprised in, a terminal device such as an NR terminal device using mmWave communications.

NR-Lite devices may be required to be single data path devices with no MIMO in order to save costs. However, millimeter wave, mmWave, communications may require that the TX and/or RX have dual-polarized antennas to ensure that the TX and RX antennas are lined up. Therefore, for NR-Lite devices without MIMO or dual polarization, a communication requirement may be that the gNB has a dual polarized antenna and radio frequency line up. In other words, communication may be possible between an NR-Lite device with single polarization and a gNB with dual polarization. However, there may be a challenge if an NR-Lite device with single polarization is required to communicate with another NR-Lite device with single polarization. If the polarizations of the two NR-Lite devices are misaligned, in the worst case the receiving device may not be able to receive any of the transmitted signal power.

Some exemplary embodiments may be used for improving device-to-device communication between devices with single antenna polarization. Some exemplary embodiments for device-to-device communication may use the PC5 interface, which is an interface for device-to-device communication, or the Uu interface, which is an interface that may be used for communication for example between a gNB and a terminal device. The devices may be reduced to single RF lineup architecture, i.e. having no MIMO support. The devices may support dual feed patch antennas so that they can switch between vertical and horizontal polarization.

FIG. 5 illustrates an architecture for an apparatus with no MIMO support according to an exemplary embodiment. In other words, the apparatus illustrated in FIG. 5 is reduced to single RF lineup architecture comprising only one transmission antenna array and only one receiving antenna array. The apparatus illustrated in FIG. 5 comprises a polarization controller 501, which may be used to request the antenna element switches to switch antenna polarization to either horizontal polarization, H, or vertical polarization, V. The apparatus illustrated in FIG. 5 may be an apparatus such as, or comprised in, a terminal device, such as an NR-Lite device.

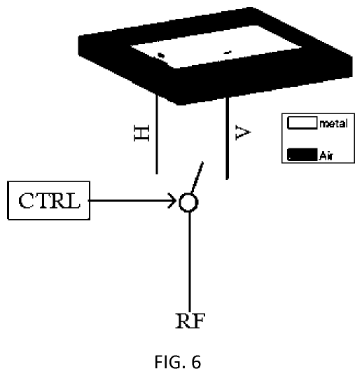

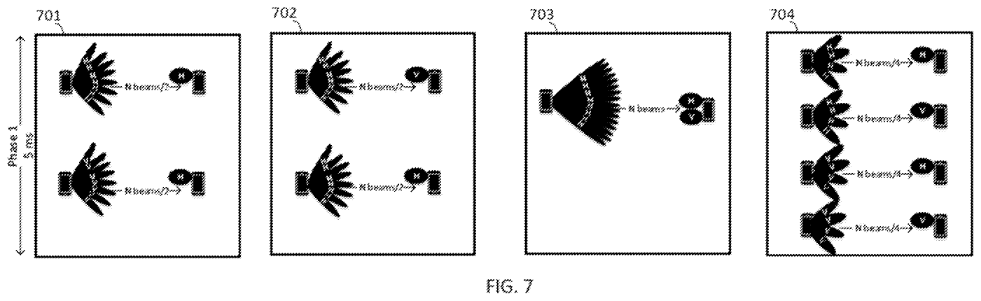

FIG. 6 illustrates a switched polarization dual feed antenna array element/patch according to an exemplary embodiment. The array element/patch may be comprised in an antenna array configuration of multiple array elements to increase the available antenna gain. The antenna array may be comprised for example in a terminal device, such as an NR-Lite device. The antenna array supports dual feed antenna patches, so that the single RF lineup can be switched to either horizontal polarization, H, or vertical polarization, V, on a per antenna element basis.

A first terminal device may perform an initial access procedure in order to establish communication with another node, for example a second terminal device. When the master node, for example the first terminal device, performs an initial access procedure, it may scan through three phases. Phase 1 of the initial access procedure is denoted herein as P1, phase 2 as P2, and phase 3 as P3. In P1, the master node may transmit up to 64 SSBs, each with a different beam. However, if both the TX and RX have single polarization, it may be difficult to establish communication between the two nodes. This issue may be addressed by some exemplary embodiments described below.

In an exemplary embodiment for the initial access procedure, the transmitting node, which may also be referred to as a first terminal device or a master node, and the receiving node, which may also be referred to as a second terminal device or a slave node, may reduce the number of beams for example from 64 to 32 or 16. Each beam may then be repeated two times if using 32 beams, or four times if using 16 beams, thus enabling the transmitting and receiving node to select the best link from multiple combinations of transmitting and receiving polarization.

FIG. 7 illustrates some exemplary embodiments for device-to-device initial access for single polarization devices, such as a terminal device according to an exemplary embodiment. In FIG. 7, four alternative exemplary embodiments for lining up polarization for initial access are illustrated in blocks 701, 702, 703 and 704, respectively. These exemplary embodiments may use the 64 SSB beam sweep as a baseline.

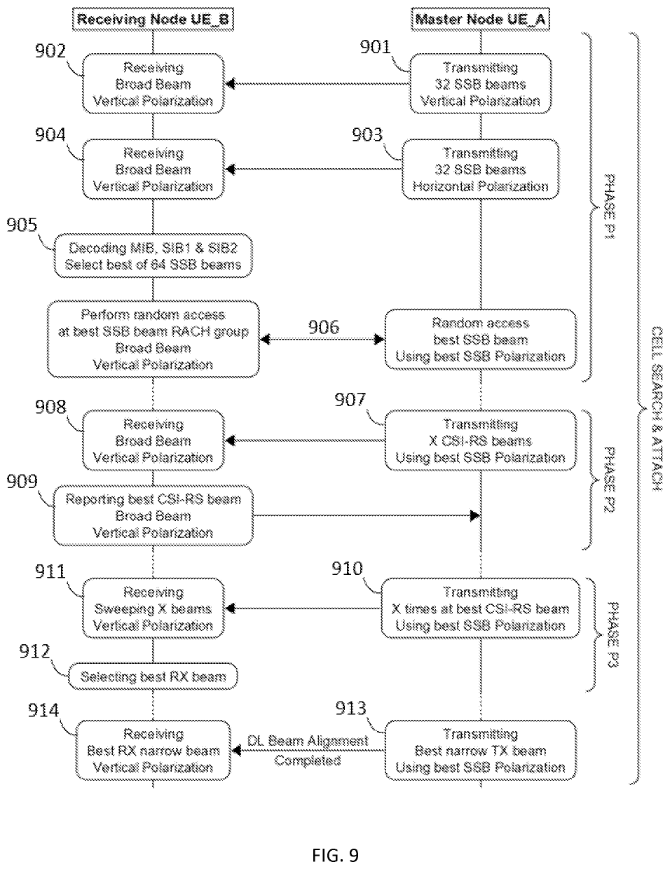

In an exemplary embodiment, as illustrated in block 701, initial access is performed via SSB repetition using switched TX polarization. The master node, i.e. the transmitting node, reduces the number of beams for example to 32 and repeats each beam for example twice in the time domain, the first one for example with horizontal polarization and the second one for example with vertical polarization. The receiving node maintains a single polarization throughout the entire P1 procedure. A flow chart corresponding to this exemplary embodiment is illustrated in FIG. 9.

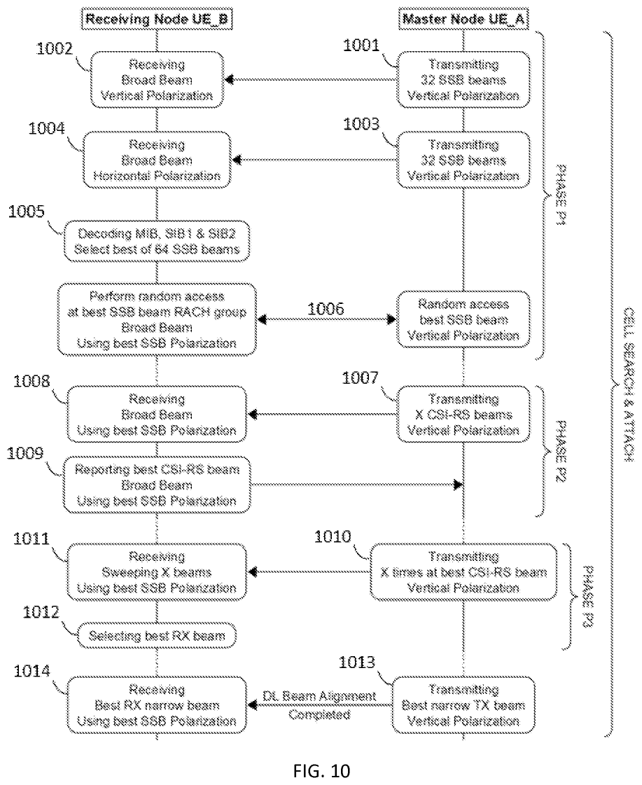

In another exemplary embodiment, as illustrated in block 702, initial access is performed via SSB repetition using switched RX polarization. The master node, i.e. the transmitting node, reduces the number of beams for example to 32 and repeats each beam for example twice in the time domain. The transmitting node maintains a single polarization throughout the entire P1 procedure. The receiving node alternates the polarization between vertical and horizontal polarization in the time domain. A flow chart corresponding to this exemplary embodiment is illustrated in FIG. 10.

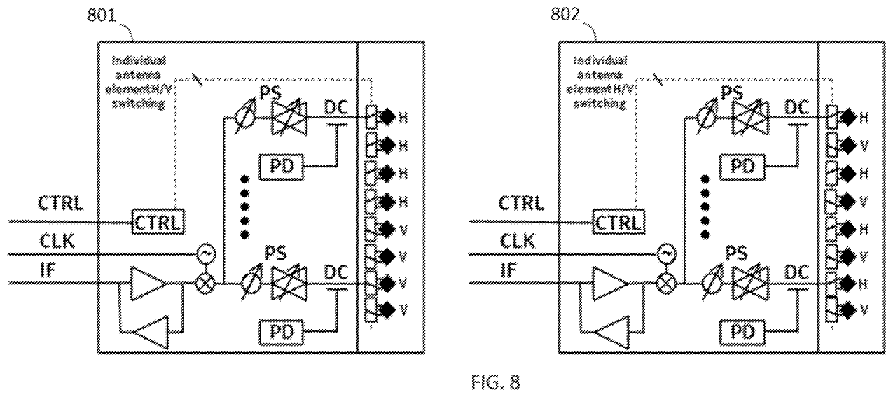

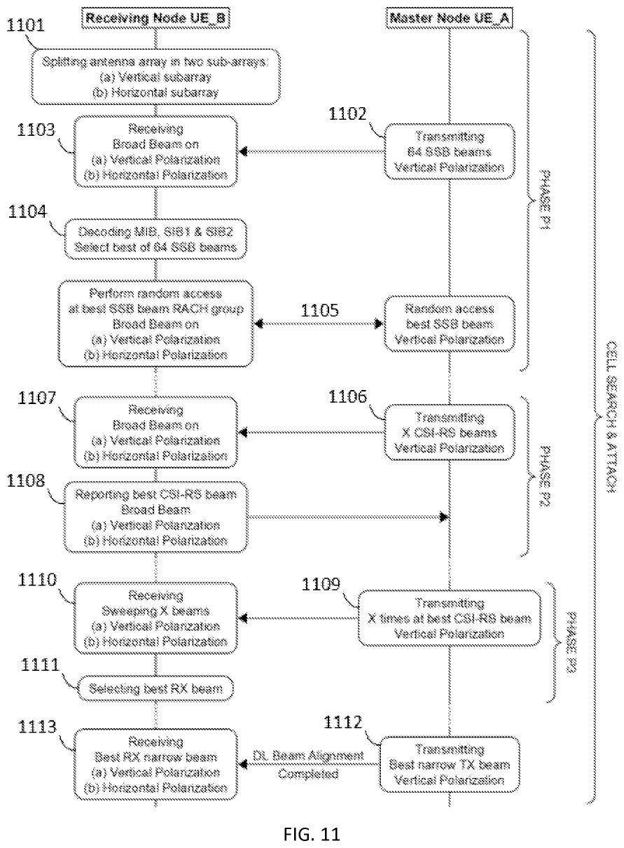

In another exemplary embodiment, as illustrated in block 703, initial access is performed via SSB using a polarization split antenna array. The master node, i.e. the transmitting node, maintains a single polarization throughout a full 64 spatial beam SSB sweep. In the receiving node, the antenna array is split into two subarrays: one configured for vertical polarization and the other for horizontal polarization, but both summed and connected to the single receiver chain. Examples of such subarray configurations are illustrated in FIG. 8, and a flow chart corresponding to this exemplary embodiment is illustrated in FIG. 11.

However, it should be noted that during the P1 phase, the terminal device with the polarization split antenna array may use a broad RX beam with lower gain than achievable by using the full array. The potential antenna gain loss by splitting the array into two subarrays may be small, for example 0-3 dB depending on the configuration used, since the radiation beamwidth may be more important in this phase, and may be achieved by using only one element of the array. However, the full array may also be configured with approximately the same gain as a single patch, but with a broader radiation beamwidth.

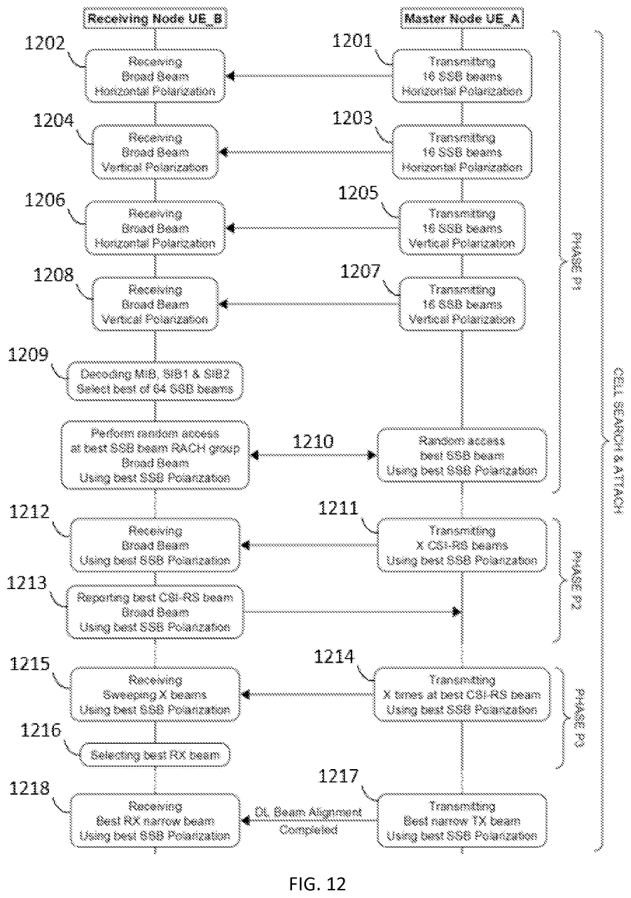

In another exemplary embodiment, as illustrated in block 704, initial access is performed via SSB repetition using switched RX polarization and switched TX polarization. The master node, i.e. the transmitting node, reduces the number of spatial beams for example to 16 and repeats each one for example four times in the time domain. The transmitting node alternates the polarization between vertical and horizontal polarization throughout the entire P1 procedure in the time domain. The receiving node also alternates the polarization between vertical and horizontal polarization throughout the entire P1 procedure in the time domain. This may be done for example with the TX performing an H-H-V-V polarization sequence and the RX performing an H-V-H-V polarization sequence, or any other combination enabling a full RX and TX sweep. A flow chart corresponding to this exemplary embodiment is illustrated in FIG. 12.

Table 1 below includes a comparison of the four exemplary embodiments for initial access described above. The first three options, i.e. the exemplary embodiments illustrated in blocks 701, 702 and 703, respectively, may provide the most gain from an antenna gain point of view during the initial access P1 procedure, while the fourth option, i.e. the exemplary embodiment illustrated in block 704, may provide an improved polarization lineup as it may also account for channel interference.

TABLE 1

| Initial access | | Polarization | |
|---|---|---|---|
| option | Antenna gain | lineup | Acquisition speed |
| 1 | Max-3 dB(TX) | Good | 64 SSB sweep (5 ms) |
| 2 | Max-3 dB(TX) | Good | 64 SSB sweep (5 ms) |
| 3 | Max-[0-3]dB(RX) | Good | 64 SSB sweep (5 ms) |
| 4 | Max-6 dB(TX) | Best | 64 SSB sweep (5 ms) |

The P2 and P3 procedures may be performed in a similar fashion, since the polarization has been lined up in the P1 phase, except for option 3 for which RX may remain at −3 dB throughout the complete initial access procedure, and be regained when entering radio resource control, RRC, connected mode.

FIG. 8 illustrates some exemplary embodiments for 1:8 antenna array polarization split. The split between horizontal, H, and vertical, V, patches is done differently in the two options illustrated in FIG. 8. In the first option, as illustrated in block 801, the upper four elements are configured for horizontal polarization, and the lower four elements are configured for vertical polarization. The second option, as illustrated in block 802, comprises interleaved horizontal and vertical elements.

FIG. 9 illustrates a flow chart according to an exemplary embodiment, wherein initial access is performed via SSB repetition using switched TX polarization. A master node, for example a first terminal device denoted herein as UE_A, reduces its spatial SSB beams for example from 64 to 32, which may reduce the TX antenna gain by approximately 3 dB covering the same sector.

In step 901, UE_A transmits a first set of 32 SSB beams with vertical polarization. In step 902, a receiving node, for example a second terminal device denoted herein as UE_B, receives the first set of SSB beams using broad RX beam with vertical polarization. In step 903, UE_A transmits a second set of 32 SSB beams equal to the first set, but with horizontal polarization. In step 904, UE_B receives the second set of SSB beams using broad RX beam with vertical polarization. In step 905, UE_B decodes MIB, SIB1 and SIB2 for the received SSB beams, and determines, for example based on RSRP, CQI, and/or RI measurements, the best, or optimal, SSB beam and polarization out of the up to 64 SSB beams decoded. In step 906, a random access procedure between UE_A and UE_B is performed with UE_B using broad beam with vertical polarization, and UE_A using the best SSB beam and polarization as determined by UE_B.

In step 907, UE_A transmits a plurality of narrow CSI-RS beams with the best SSB polarization. In step 908, UE_B receives said CSI-RS beams using broad beam with vertical polarization. In step 909, UE_B determines, for example based on RSRP, CQI, and/or RI measurements, the best CSI-RS beam and reports it to UE_A using broad beam and vertical polarization.

In step 910, UE_A transmits the best narrow CSI-RS beam, as determined by UE_B, multiple times with the best SSB polarization. In step 911, UE_B receives said narrow CSI-RS beam and measures the received beam while sweeping its RX narrow beam with vertical polarization. In step 912, UE_B determines the best RX beam for example based on RSRP, CQI, and/or RI measurements.

In step 913, UE_A transmits the best narrow TX beam using the best SSB polarization. In step 914, UE_B receives the best narrow RX beam using vertical polarization, and thus downlink beam alignment including polarization alignment is accomplished.

It should be noted that 64 beams is used only as an example in the above exemplary embodiment, and some exemplary embodiments are not limited to using 64 beams. A different number of beams may be used instead in some exemplary embodiments.

Furthermore, the receiving node may select either vertical or horizontal polarization as fixed throughout the initial access procedure. In other words, in some exemplary embodiments the receiving node may use horizontal polarization instead of vertical polarization in a procedure otherwise similar to the one illustrated in FIG. 9.

In another exemplary embodiment, the master node may transmit the two sets of 32 SSB beams with vertical or horizontal polarization in an interleaved pattern instead of sequentially.

FIG. 10 illustrates a flow chart according to an exemplary embodiment, wherein initial access is performed via SSB repetition using switched RX polarization. A master node, for example a first terminal device denoted herein as UE_A, reduces its spatial SSB beams for example from 64 to 32, which may reduce the TX antenna gain by approximately 3 dB covering the same sector.

In step 1001, UE_A transmits a first set of 32 SSB beams with vertical polarization. In step 1002, a receiving node, for example a second terminal device denoted herein as UE_B, receives the first set of SSB beams using broad RX beam with vertical polarization. In step 1003, UE_A transmits a second set of 32 SSB beams equal to the first set and with vertical polarization. In step 1004, UE_B receives the second set of SSB beams using broad RX beam with horizontal polarization. In step 1005, UE_B decodes MIB, SIB1 and SIB2 for the received SSB beams, and determines, for example based on RSRP, CQI, and/or RI measurements, the best, or optimal, SSB beam and polarization out of the up to 64 SSB beams decoded. In step 1006, a random access procedure between UE_A and UE_B is performed with UE_B using broad beam with the determined best SSB polarization, and UE_A using the determined best SSB beam and vertical polarization.

In step 1007, UE_A transmits a plurality of narrow CSI-RS beams with vertical polarization. In step 1008, UE_B receives said CSI-RS beams using broad beam with the best SSB polarization. In step 1009, UE_B determines, for example based on RSRP, CQI, and/or RI measurements, the best CSI-RS beam and reports it to UE_A using broad beam and the best SSB polarization.

In step 1010, UE_A transmits the best narrow CSI-RS beam, as determined by UE_B, multiple times with vertical polarization. In step 1011, UE_B receives said narrow CSI-RS beam and measures the received beam while sweeping its RX narrow beam with the best SSB polarization. In step 1012, UE_B determines the best RX beam for example based on RSRP, CQI, and/or RI measurements.

In step 1013, UE_A transmits the best narrow TX beam using vertical polarization. In step 1014, UE_B receives the best narrow RX beam using the best SSB polarization, and thus downlink beam alignment including polarization alignment is accomplished.

It should be noted that 64 beams is used only as an example in the above exemplary embodiment, and some exemplary embodiments are not limited to using 64 beams. A different number of beams may be used instead in some exemplary embodiments.

Furthermore, the master node may select either vertical or horizontal polarization as fixed throughout the initial access procedure. In other words, in some exemplary embodiments the master node may use horizontal polarization instead of vertical polarization in a procedure otherwise similar to the one illustrated in FIG. 10.

In another exemplary embodiment, the receiving node may receive the two sets of 32 SSB beams with vertical or horizontal polarization in an interleaved pattern instead of sequentially.

FIG. 11 illustrates a flow chart according to an exemplary embodiment, wherein initial access is performed via SSB using a polarization split antenna array. In step 1101, a receiving node, for example a second terminal device denoted herein as UE_B, splits its antenna array into two sub-arrays both simultaneously connected to the single receiver chain, wherein the first sub-array uses vertical polarization and the second sub-array uses horizontal polarization. In step 1102, a master node, for example a first terminal device denoted herein as UE_A, transmits for example 64 SSB beams with vertical polarization. In step 1103, UE_B receives the SSB beams using broad RX beam on both sub-arrays with vertical and horizontal polarization. In step 1104, UE_B decodes MIB, SIB1 and SIB2 for the received SSB beams, and determines, for example based on RSRP, CQI, and/or RI measurements, the best, or optimal, SSB beam and polarization out of the up to 64 SSB beams decoded. In step 1105, a random access procedure between UE_A and UE_B is performed with UE_B using broad beam on both sub-arrays with vertical and horizontal polarization, and UE_A using the best SSB beam, as determined by UE_B, and vertical polarization.

In step 1106, UE_A transmits a plurality of narrow CSI-RS beams with vertical polarization. In step 1107, UE_B receives the CSI-RS beams using broad RX beam on both sub-arrays with vertical and horizontal polarization. In step 1108, UE_B determines, for example based on RSRP, CQI, and/or RI measurements, the best CSI-RS beam and reports it to UE_A using broad beam on both sub-arrays with vertical and horizontal polarization.

In step 1109, UE_A transmits the best narrow CSI-RS beam multiple times with vertical polarization. In step 1110, UE_B receives the best CSI-RS beam while sweeping its RX narrow beam on both sub-arrays with vertical and horizontal polarization. In step 1111, UE_B determines the best RX beam for example based on RSRP, CQI, and/or RI measurements.

In step 1112, UE_A transmits the best narrow TX beam with vertical polarization. In step 1113, UE_B receives the best narrow RX beam using vertical and horizontal polarization, and thus beam alignment including polarization alignment is accomplished.

It should be noted that 64 beams is used only as an example in the above exemplary embodiment, and some exemplary embodiments are not limited to using 64 beams. A different number of beams may be used instead in some exemplary embodiments.

Furthermore, the master node may select either vertical or horizontal polarization as fixed throughout the initial access procedure. In other words, in some exemplary embodiments the master node may use horizontal polarization instead of vertical polarization in a procedure otherwise similar to the one illustrated in FIG. 11.

In another exemplary embodiment, the receiving node may remain in split array configuration, and an update to full array single polarization may be part of the RRC connected polarization synchronization procedures.

FIG. 12 illustrates a flow chart according to an exemplary embodiment, wherein initial access is performed via SSB repetition using switched RX polarization and switched TX polarization. A master node, for example a first terminal device denoted herein as UE_A, reduces its spatial SSB beams for example from 64 to 16, which may reduce the TX antenna gain by approximately 6 dB covering the same sector.

In step 1201, UE_A transmits a first set of 16 SSB beams with horizontal polarization. In step 1202, a receiving node, for example a second terminal device denoted herein as UE_B, receives the first set of SSB beams using broad RX beam with horizontal polarization. In step 1203, UE_A transmits a second set of 16 SSB beams equal to the first set and with horizontal polarization. In step 1204, UE_B receives the second set of SSB beams using broad RX beam with vertical polarization. In step 1205, UE_A transmits a third set of 16 SSB beams equal to the first set and with vertical polarization. In step 1206, UE_B receives the third set of SSB beams using broad RX beam with horizontal polarization. In step 1207, UE_A transmits a fourth set of 16 SSB beams equal to the first set and with vertical polarization. In step 1208, UE_B receives the fourth set of SSB beams using broad RX beam with vertical polarization. In step 1209, UE_B decodes MIB, SIB1 and SIB2 for the received SSB beams, and determines, for example based on RSRP, CQI, and/or RI measurements, the best, or optimal, SSB beam and polarization out of the up to 64 SSB beams decoded. In step 1210, a random access procedure between UE_A and UE_B is performed with UE_B using broad beam with the determined best SSB polarization, and UE_A using the best SSB beam and the best SSB polarization as determined by UE_B.

In step 1211, UE_A transmits a plurality of narrow CSI-RS beams with the best SSB polarization. In step 1212, UE_B receives said CSI-RS beams using broad beam with the best SSB polarization. In step 1213, UE_B determines, for example based on RSRP, CQI, and/or RI measurements, the best CSI-RS beam and reports it to UE_A using broad beam and the best SSB polarization.

In step 1214, UE_A transmits the best narrow CSI-RS beam, as determined by UE_B, multiple times with the best SSB polarization. In step 1215, UE_B receives said narrow CSI-RS beam and measures the received beam while sweeping its RX narrow beam with the best SSB polarization. In step 1216, UE_B determines the best RX beam for example based on RSRP, CQI, and/or RI measurements.

In step 1217, UE_A transmits the best narrow TX beam using the best SSB polarization. In step 1218, UE_B receives the best narrow RX beam using the best SSB polarization, and thus downlink beam alignment including polarization alignment is accomplished.

It should be noted that 64 beams is used only as an example in the above exemplary embodiment, and some exemplary embodiments are not limited to using 64 beams. A different number of beams may be used instead in some exemplary embodiments.

In another exemplary embodiment, the master node and/or receiving node may transmit and/or receive, respectively, the four sets of 16 SSB beams with vertical or horizontal polarization in an interleaved pattern instead of sequentially.

In another exemplary embodiment, the signals may be repeated three times instead of four, i.e. the master node may transmit three sets of 16 SSB beams instead of four sets, since the channel V-H polarization and H-V polarization may be the same. In this case, the most relevant cases may be H-H, H-V or V-H, and V-V.

In an RRC connected mode according to an exemplary embodiment, dynamically configured reference symbols, for example orthogonal frequency-division multiplexing, OFDM, symbols, may be extended such that the receiving node receives each reference symbol in both polarizations and selects the best polarization. The reference symbols may be transmitted for example via a demodulation reference signal, DMRS, and/or CSI-RS. Alternatively, repetition by a factor of two may be used, wherein the first data package is received with one polarization, and the second package is received with the other polarization. The two data packages may then be soft-combined, i.e. added before decoding. This option may exhibit full performance as a dual polarized implementation, for example 2 stream MIMO with rank 1, although throughput may be reduced.

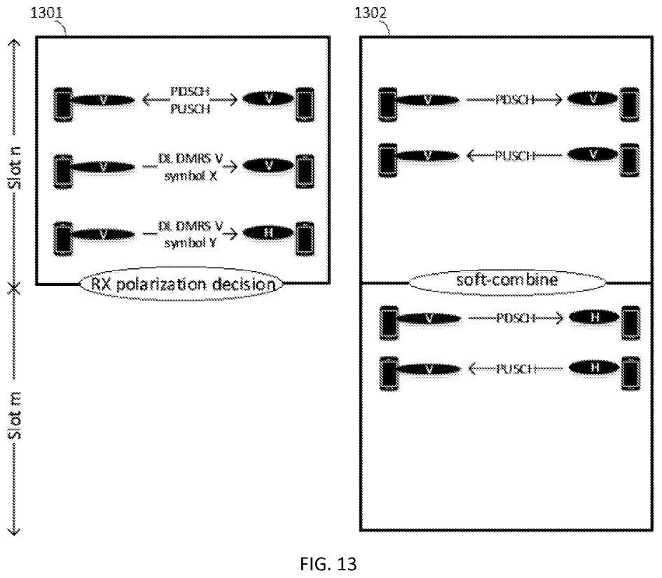

FIG. 13 illustrates some exemplary embodiments for the RRC connected mode. In FIG. 13, two alternative exemplary embodiments for the RRC connected mode are illustrated in blocks 1301 and 1302, respectively.

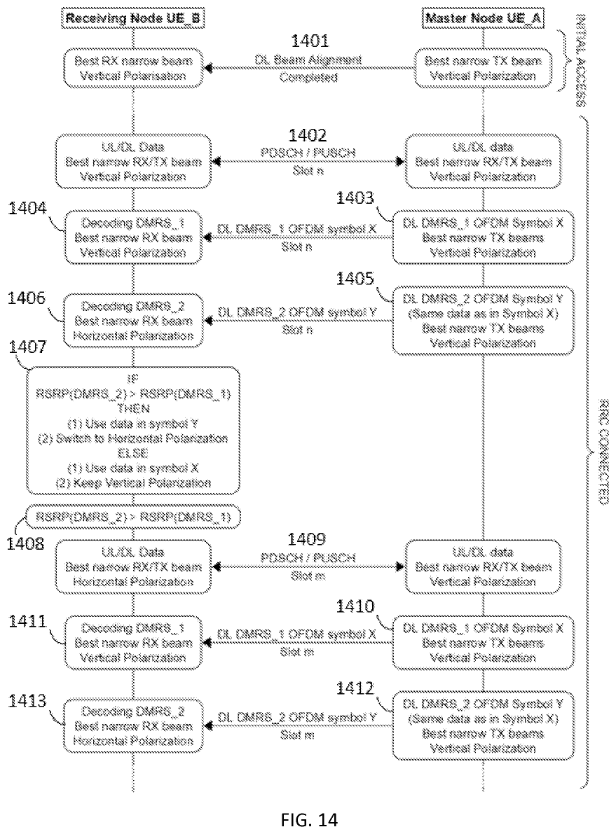

In an exemplary embodiment, as illustrated in block 1301, RRC connected mode uses additional DMRS and/or CSI-RS together with switched RX polarization. The transmitting node periodically transmits reference signals, for example DMRS and/or CSI-RS. The number of reference symbols may be configured dynamically. For example, the number of reference symbols may be increased, so that the first reference symbol is received in one polarization, for example vertical, and the second reference symbol is received in the other polarization, for example horizontal. Based on the best signal level, measured for example by received signal strength indicator, RSSI, and decoded signal level, measured for example by RSRP, one polarization may be selected over the other. This exemplary embodiment may have a slight overhead in the additional reference symbols, but it may enable a low cost implementation. A flow chart corresponding with this exemplary embodiment is illustrated in FIG. 14.

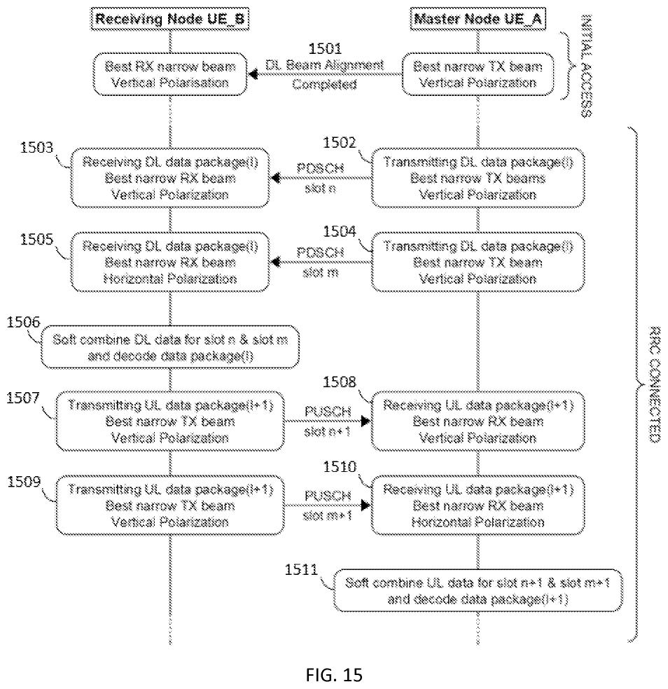

In another exemplary embodiment, as illustrated in block 1302, RRC connected mode uses two-time repetition together with switched RX polarization. The entire data package may be repeated, so that the first data package is received with one polarization, for example vertical, and the second package is received in the other polarization, for example horizontal. The two data packages may then be soft combined, i.e. added before decoding. This exemplary embodiment may have full performance as a dual polarized implementation, for example 2 stream MIMO with rank 1, but with a possible drawback of reduced throughput. A flow chart corresponding with this exemplary embodiment is illustrated in FIG. 15.

FIG. 14 illustrates a flow chart according to an exemplary embodiment, wherein RRC connected mode uses additional DMRS and/or CSI-RS together with switched RX polarization. In step 1401, initial access downlink beam alignment is obtained with vertical polarization selected for both the master node, for example a first terminal device denoted herein as UE_A, and the receiving node, for example a second terminal device denoted herein as UE_B.

In step 1402, an RRC link is established between UE_A and UE_B, and physical downlink shared channel, PDSCH, and/or physical uplink shared channel, PUSCH, data is transmitted by UE_A and received by UE_B in slot n with both UE_A and UE_B antenna arrays vertically polarized. n denotes a slot index. In step 1403, UE_A transmits a first reference signal, denoted as DMRS_1, in slot n symbol X with vertical polarization. In step 1404, UE_B receives DMRS_1 with vertical polarization, and decodes DMRS_1. In step 1405, UE_A transmits a second reference signal, denoted as DMRS_2, in slot n symbol Y with vertical polarization. In step 1406, UE_B receives DMRS_2 with horizontal polarization, and decodes DMRS_2. In step 1407, UE_B evaluates RSRP for DMRS_1 and DMRS_2. If the RSRP of DMRS_2 is greater than the RSRP of DMRS_1, then UE_B uses data in symbol Y and switches to horizontal polarization for slot m, wherein m denotes another slot index. If the RSRP of DMRS_2 is not greater than the RSRP of DMRS_1, then UE_B uses data in symbol X and keeps vertical polarization for slot m. In step 1408, UE_B confirms that the RSRP of DMRS_2 is greater than the RSRP of DMRS_1.

In step 1409, PDSCH and/or PUSCH data is transmitted by UE_A and received by UE_B in slot m with UE_A using vertical polarization and UE_B using horizontal polarization. In step 1410, UE_A transmits DMRS_1 in slot m symbol X with vertical polarization. In step 1411, UE_B receives DMRS_1 with vertical polarization, and decodes DMRS_1. In step 1412, UE_A transmits DMRS_2 in slot m symbol Y with vertical polarization. In step 1413, UE_B receives DMRS_2 with horizontal polarization, and decodes DMRS_2. After step 1413, the slot index is updated, and the process may be iterative so that it returns to step 1407 and continues from there.

It should be noted that the additional DMRS signal may be an extra symbol dedicated for polarization tracking, or it can be specified that the symbols reserved for dmrsAdditionalPosition are reserved for the other polarization. Furthermore, the polarization may be specified for example by defining a new data container AdditionalDMRS-Polarization.

In another exemplary embodiment, the data in symbols X and Y may be soft-combined.

In another exemplary embodiment there may be no data in symbols X and Y, but only the DMRS.

FIG. 15 illustrates a flow chart according to an exemplary embodiment, wherein RRC connected mode uses two-time repetition together with switched RX polarization. In step 1501, initial access downlink beam alignment is obtained with vertical polarization selected for both the master node, for example a first terminal device denoted herein as UE_A, and the receiving node, for example a second terminal device denoted herein as UE_B.

In step 1502, UE_A transmits a PDSCH data package in slot n with vertical polarization. In step 1503, UE_B receives the PDSCH data package in slot n with vertical polarization. In step 1504, UE_A re-transmits the PDSCH data package in slot m with vertical polarization. In step 1505, UE_B receives the re-transmitted PDSCH data package in slot m with horizontal polarization. In step 1506, UE_B soft-combines the received downlink data from slot n and m, and decodes the PDSCH data package.

In step 1507, UE_B transmits a PUSCH data package in slot n with vertical polarization. In step 1508, UE_A receives the PUSCH data package in slot n with vertical polarization. In step 1509, UE_B re-transmits the PUSCH data package in slot m with vertical polarization. In step 1510, UE_A receives the re-transmitted PUSCH data package in slot m with horizontal polarization. In step 1511, UE_A soft combines the received uplink data from slot n and m and decodes the PUSCH data package.

In another exemplary embodiment, the transmitter may switch polarization for re-transmission of the data package, and the receiver polarization may remain fixed.

In RRC connected mode, because of polarization tracking, the devices may spend additional resources either by repeating the DMRS signal or by repeating the entire data package, depending on whether polarization tracking follows the exemplary embodiment illustrated in FIG. 14 or the exemplary embodiment illustrated in FIG. 15. However, if it can be detected that the devices are static and/or the channel is not changing over time, there may be no need for occupying resources for polarization tracking.

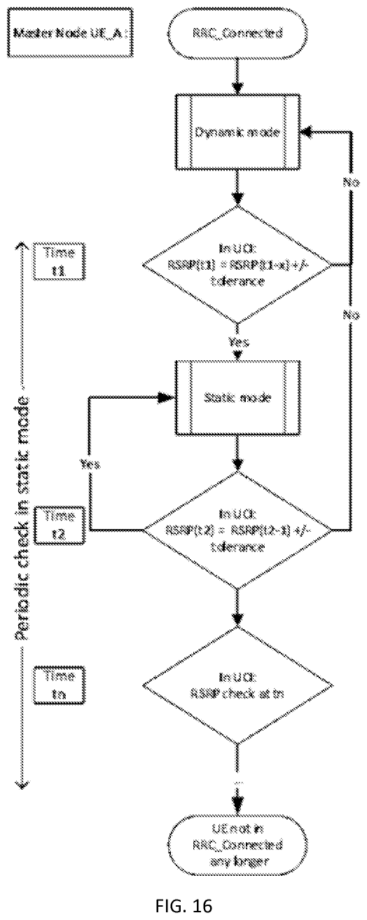

FIG. 16 illustrates a flow chart according to an exemplary embodiment for optimizing resources when a static channel is detected. The process starts with the master node, for example a first terminal device denoted as UE_A, in dynamic mode. If a static condition is detected by UE_A, for example based on consistent RSRP reports, UE_A may enter static mode, wherein it interrupts the repetition of DMRS or data, depending on the chosen procedure, in order to better utilize the downlink resources and/or increase throughput. As soon as the static condition is broken, UE_A may decide to reintroduce the DMRS repetition or the data repetition, depending on the chosen procedure, to improve polarization tracking and link budget, and to avoid link interruptions. UE_A may periodically check the static condition and adjust accordingly. Whether UE_A operates with static mode or not may be identified by the receiving node, UE_B, for example in the DMRS-DownlinkConfig. In FIG. 16, t1-x represents that the static condition is assessed over time for example with a timer or a counter. The dynamic condition may only need 1, or a number less than or equal to x, to be assessed. The periodicity of the check for static mode may be adapted to the link evaluation.

It should be noted that instead of or in addition to RSRP, some exemplary embodiments may use for example signal-to-interference-plus-noise ratio, SINR, and/or any other channel quality indicator for link evaluation.

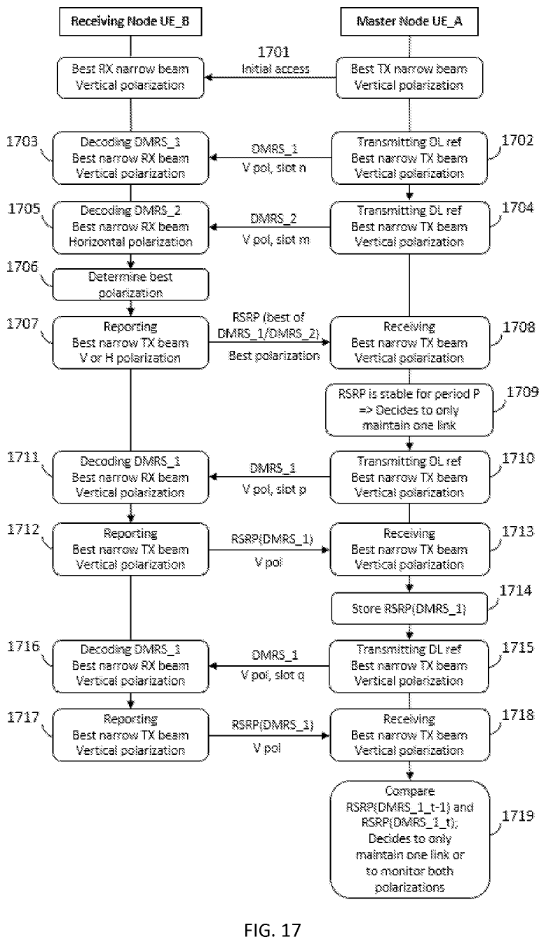

If the master node, UE_A, cannot switch polarization and only exhibits a single polarization, this may be informed to the receiving node, UE_B. FIG. 17 illustrates a flow chart according to an exemplary embodiment for identifying a static case when only the receiving node is able to switch polarization. In a static case, repetitions may be omitted to increase throughput.

In step 1701, initial access downlink beam alignment is obtained with vertical polarization selected for both the master node, for example a first terminal device denoted herein as UE_A, and the receiving node, for example a second terminal device denoted herein as UE_B.

In step 1702, UE_A transmits a first downlink reference signal, denoted as DMRS_1, in slot n with vertical polarization. In step 1703, UE_B receives DMRS_1 with vertical polarization, and decodes it. In step 1704, UE_A transmits a second downlink reference signal, denoted as DMRS_2, in slot m with vertical polarization. In step 1705, UE_B receives DMRS_2 with horizontal polarization, and decodes it. In step 1706, UE_B evaluates RSRP of DMRS_1 and DMRS_2, determines the best one out of these two signals based on the RSRP measurements, and determines the best polarization. In step 1707, UE_B reports the RSRP measurements of the best signal, i.e. DMRS_1 or DMRS_2, to UE_A with the best polarization, i.e. vertical or horizontal polarization. In step 1708, UE_A receives the report with vertical polarization.

In step 1709, if RSRP has remained stable for a pre-defined period of time, UE_A decides to maintain only one link in order to improve throughput. In step 1710, UE_A transmits DMRS_1 in slot p to UE_B with vertical polarization. In step 1711, UE_B receives DMRS_1 with vertical polarization, and decodes it. In step 1712, UE_B reports the RSRP measurements of DMRS_1 to UE_A with vertical polarization, and in step 1713 UE_A receives the report with vertical polarization. In step 1714, UE_A stores the RSRP measurements of DMRS_1 reported by UE_B for example in an internal memory of UE_A.

In step 1715, UE_A transmits DMRS_1 in slot q to UE_B with vertical polarization. In step 1716, UE_B receives DMRS_1 with vertical polarization, and decodes it. In step 1717, UE_B reports the RSRP measurements of DMRS_1 to UE_A with vertical polarization, and in step 1718 UE_A receives the report with vertical polarization.

In step 1719, UE_A compares the RSRP measurements received in step 1713 and the RSRP measurements received in step 1718. Based on the comparison, UE_A may then decide to maintain only one link or to monitor both polarizations again.

If the receiving node, for example a second terminal device denoted as UE_B, cannot switch polarization and only exhibits a single polarization, this may be informed to the master node for example in a UE capabilities or UE assistance message. During communication, UE_B may report the best current polarization. Based on the reports, the master node, UE_A, may decide to avoid the repetitions to increase throughput.

In another exemplary embodiment, the initial access procedure may be reversed, so that UE_B initiates and the control is done on sounding reference signal, SRS, instead of on DMRS, i.e. in uplink.

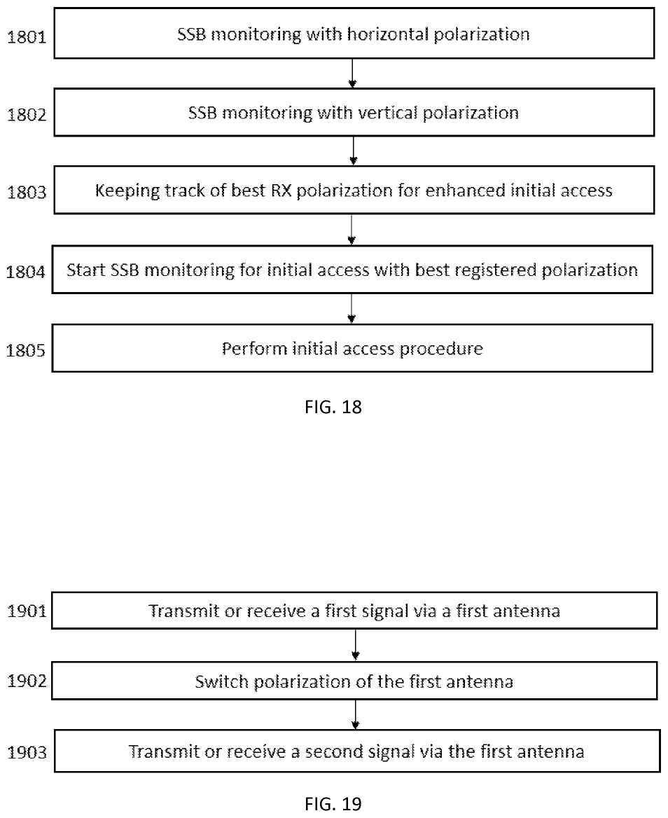

FIG. 18 illustrates a flow chart according to an exemplary embodiment for idle mode polarization tracking. In idle mode, UE_B may already identify its best polarization to expedite the initial access procedure. In step 1801, UE_B performs SSB monitoring with horizontal polarization. In step 1802, UE_B performs SSB monitoring with vertical polarization. In step 1803, UE_B keeps track of the best RX polarization for enhanced initial access. In step 1804, UE_B starts SSB monitoring for initial access with the best registered polarization. In step 1805, the initial access procedure is performed.

FIG. 19 illustrates a flow chart according to an exemplary embodiment. The steps and/or functions illustrated in FIG. 19 may be performed by an apparatus, such as a terminal device according to an exemplary embodiment. In step 1901, a first signal is transmitted or received via a first antenna, said first signal transmitted to or received from a second terminal device. In step 1902, a polarization of the first antenna is switched. In step 1903, a second signal is transmitted or received via the first antenna, said second signal transmitted to or received from the second terminal device.

It should be noted that some exemplary embodiments may not be limited to vertical and horizontal polarization. For example, some exemplary embodiments may be configured to switch between right circular polarization and left circular polarization.

A technical advantage provided by some exemplary embodiments may be that reliability of connectivity may be increased and latency may be reduced in device-to-device communication for example between two terminal devices. In addition, some exemplary embodiments may enable sidelink communication for example between two NR-Lite terminal devices comprising only one transmitter and only one receiver.

The functions and/or steps described above by means of FIGS. 9-19 are in no absolute chronological order, and some of them may be performed simultaneously or in an order differing from the described one. Other functions and/or steps may also be executed between them or within them.

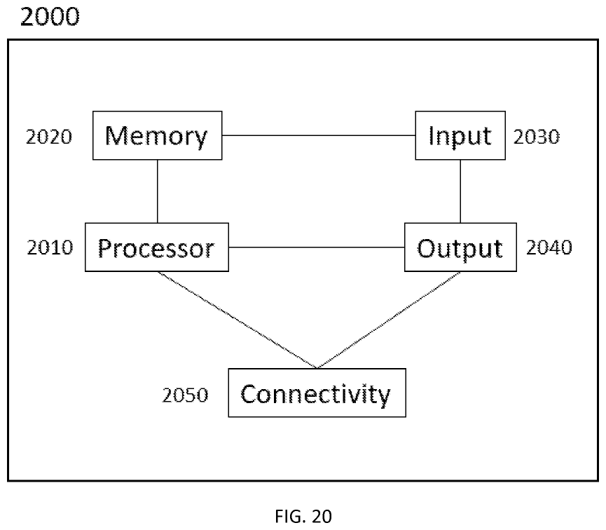

FIG. 20 illustrates an apparatus 2000, which may be an apparatus such as, or comprised in, a terminal device, according to an exemplary embodiment. The apparatus 2000 comprises a processor 2010. The processor 2010 interprets computer program instructions and processes data. The processor 2010 may comprise one or more programmable processors. The processor 2010 may comprise programmable hardware with embedded firmware and may, alternatively or additionally, comprise one or more application specific integrated circuits, ASICs.

The processor 2010 is coupled to a memory 2020. The processor is configured to read and write data to and from the memory 2020. The memory 2020 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 2020 stores computer readable instructions that are execute by the processor 2010. For example, non-volatile memory stores the computer readable instructions and the processor 2010 executes the instructions using volatile memory for temporary storage of data and/or instructions.

The computer readable instructions may have been pre-stored to the memory 2020 or, alternatively or additionally, they may be received, by the apparatus, via electromagnetic carrier signal and/or may be copied from a physical entity such as computer program product. Execution of the computer readable instructions causes the apparatus 2000 to perform functionality described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 2000 may further comprise, or be connected to, an input unit 2030. The input unit 2030 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 2030 may comprise an interface to which external devices may connect to.

The apparatus 2000 may also comprise an output unit 2040. The output unit may comprise or be connected to one or more displays capable of rendering visual content such as a light emitting diode, LED, display, a liquid crystal display, LCD and a liquid crystal on silicon, LCoS, display. The output unit 2040 may further comprise one or more audio outputs. The one or more audio outputs may be for example loudspeakers.

The apparatus 2000 further comprises a connectivity unit 2050. The connectivity unit 2050 enables wireless connectivity to one or more external devices. The connectivity unit 2050 comprises at least one transmitter and at least one receiver that may be integrated to the apparatus 2000 or that the apparatus 2000 may be connected to. The at least one transmitter comprises at least one transmission antenna, and the at least one receiver comprises at least one receiving antenna. The connectivity unit 2050 may comprise an integrated circuit or a set of integrated circuits that provide the wireless communication capability for the apparatus 2000. Alternatively, the wireless connectivity may be a hardwired application specific integrated circuit, ASIC. The connectivity unit 2050 may comprise one or more components such as a power amplifier, digital front end, DFE, analog-to-digital converter, ADC, digital-to-analog converter, DAC, polarization controller, frequency converter, (de)modulator, and/or encoder/decoder circuitries, controlled by the corresponding controlling units.

It is to be noted that the apparatus 2000 may further comprise various components not illustrated in FIG. 20. The various components may be hardware components and/or software components.

As used in this application, the term “circuitry” may refer to one or more or all of the following:
a. hardware-only circuit implementations (such as implementations in only analog and/or digital circuitry) and
b. combinations of hardware circuits and software, such as (as applicable):
   i. a combination of analog and/or digital hardware circuit(s) with software/firmware and
   ii. any portions of hardware processor(s) with software (including digital signal processor(s)), software, and memory(ies) that work together to cause an apparatus, such as a mobile phone, to perform various functions) and
c. hardware circuit(s) and or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus (es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1. An apparatus comprising at least one processor, and at least one memory storing instructions that, when executed by the at least one processor, cause the apparatus at least to:
transmit or receive a first signal via a first antenna, said first signal transmitted to or received from a second terminal device;
switch a polarization of the first antenna; and
transmit or receive a second signal via the first antenna, said second signal transmitted to or received from the second terminal device;
wherein the apparatus is comprised in a first terminal device.

2. An apparatus according to claim 1, wherein the polarization is switched from horizontal polarization to vertical polarization, or from vertical polarization to horizontal polarization, or from right circular polarization to left circular polarization, or from left circular polarization to right circular polarization.

3. An apparatus according to claim 1, further comprising determining an optimal polarization and/or an optimal beam from a plurality of beams, wherein the first signal and the second signal comprise at least a subset of the plurality of beams.

4. An apparatus according to claim 3, further comprising indicating the optimal polarization and/or the optimal beam to the second terminal device.

5. An apparatus according to claim 3, further comprising transmitting or receiving a third signal via the first antenna by using the optimal polarization and/or the optimal beam, said third signal transmitted to or received from the second terminal device.

6. An apparatus according to claim 1, further comprising:
comparing a quality indicator of the first signal and the second signal; and
selecting an optimal polarization of the first antenna based on the comparing;
wherein the first signal comprises a first demodulation reference signal, a first channel state information reference signal, and/or a first sounding reference signal; and
wherein the second signal comprises a second demodulation reference signal, a second channel state information reference signal, and/or a second sounding reference signal.

7. An apparatus according to claim 1, wherein the first signal comprises a first data package in a first slot, and the second signal comprises a second data package in a second slot, further comprising:
combining the first data package and the second data package; and
decoding the combined data package;
wherein the first data package comprises a first physical downlink shared channel data package or a first physical uplink shared channel data package; and
wherein the second data package comprises the first physical downlink shared channel data package or the first physical uplink shared channel data package.

8. An apparatus according to claim 1, wherein a PC5 interface or a Uu interface is used to transmit or receive the first signal and the second signal.

9. An apparatus according to claim 1, wherein the first antenna comprises a dual feed element antenna array.

10. An apparatus according to claim 1, wherein the apparatus comprises a polarization controller, which is used to request switching the polarization of the first antenna.

11. (canceled)

12. A system comprising at least:
a first terminal device and a second terminal device;
wherein the first terminal device is configured to:
transmit a first signal to the second terminal device via a first antenna;
wherein the second terminal device is configured to receive the first signal via a second antenna;
wherein the first terminal device is further configured to:
switch a polarization of the first antenna; and
transmit a second signal to the second terminal device via the first antenna;
wherein the second terminal device is further configured to receive the second signal via the second antenna.

13. A system according to claim 12, wherein the second terminal device is further configured to switch a polarization of the second antenna.

14. A system according to claim 12, wherein the second antenna comprises a first subarray and a second subarray, said first subarray configured for vertical polarization or right circular polarization, and said second subarray configured for horizontal polarization or left circular polarization.

15. A system comprising at least:
a first terminal device and a second terminal device;
wherein the first terminal device comprises means for:
transmitting a first signal to the second terminal device via a first antenna;
wherein the second terminal device comprises means for receiving the first signal via a second antenna;
wherein the first terminal device further comprises means for:
switching a polarization of the first antenna; and
transmitting a second signal to the second terminal device via the first antenna;
wherein the second terminal device further comprises means for receiving the second signal via the second antenna.

16. A method comprising:
transmitting or receiving, by a first terminal device, a first signal via a first antenna, said first signal transmitted to or received from a second terminal device;
switching, by the first terminal device, a polarization of the first antenna; and
transmitting or receiving, by the first terminal device, a second signal via the first antenna, said second signal transmitted to or received from the second terminal device.

17. A non-transitory computer readable medium comprising program instructions that, when executed by an apparatus, cause the apparatus to perform at least the following:
transmit or receive a first signal via a first antenna, said first signal transmitted to or received from a second terminal device;
switch a polarization of the first antenna; and
transmit or receive a second signal via the first antenna, said second signal transmitted to or received from the second terminal device;
wherein the apparatus is comprised in a first terminal device.

18. A method according to claim 16, wherein the polarization is switched from horizontal polarization to vertical polarization, or from vertical polarization to horizontal polarization, or from right circular polarization to left circular polarization, or from left circular polarization to right circular polarization.

19. A method according to claim 16, further comprising determining an optimal polarization and/or an optimal beam from a plurality of beams, wherein the first signal and the second signal comprise at least a subset of the plurality of beams.

20. A method according to claim 18, further comprising indicating the optimal polarization and/or the optimal beam to the second terminal device.

21. A method according to claim 18, further comprising transmitting or receiving a third signal via the first antenna by using the optimal polarization and/or the optimal beam, said third signal transmitted to or received from the second terminal device.
